(19) United States
(12) Patent Application Publication
(10) Pub. No.: US 2008/0110998 A1
(43) Pub. Date: May 15, 2008

(54) Moisture-Absorbing Polymer Particle,Method for Forming the same and Application thereof

(75) Inventors: Keh-Ying Hsu, Taoyuan (TW); Chu-Yi Pang, Taoyuan (TW)

Correspondence Address: WPAT, PC, 7225 BEVERLY ST., ANNANDALE, VA, 22003, US

(73) Assignee: CHUNG YUAN CHRISTIAN UNIVERSITY, Taoyuan (TW)

(21) Appl. No.: 12/015,852

(22) Filed: Jan. 17, 2008

Related U.S. Application Data
(62) Division of application No. 10/978,374, filed on Nov. 2, 2004, now abandoned.

(51) Int. Cl. F25D 1/00; G05D 22/02

(52) U.S. Cl. 236/44 C

(57) ABSTRACT

The present invention discloses a moisture-absorbing polymer particle, which either comprises PNIPAm crosslinking copolymer or a structure having PNIPAm crosslinking copolymer as a core and polymer with sulfonic acid group as a shell. The present invention also discloses a method for producing the provided moisture-absorbing polymer particle and an application thereof; the application is referred to as a continuous dehumidifying system which comprises a first module to perform a dehumidifying process and a second module to perform a regeneration process, wherein the dehumidifying process is performed at a temperature lower than 33° C. and the regeneration process is performed at a temperature higher than 40° C.

### CROSS REFERENCE TO RELATED APPLICATIONS

This application is a divisional application of U.S. patent application Ser. No. 10/978,374.

### BACKGROUND OF THE INVENTION

1. Field of the Invention

The present invention is generally related to a polymer particle, and more particularly to a moisture-absorbing polymer particle, a method for forming the same, and applications thereof.

2. Description of the Prior Art

In the area with a high relative humidity, product quality in manufacturing industries usually suffers damages by high humidity condition. Thus, for most advanced technology industries, such as semi-conductor, optoelectronics and pharmacy, a dry manufacturing condition, to prevent quality loss usually accounts for a great proportion in the cost/profit management.

Conventional solid absorbents used for a dehumidifying system are molecule sieves or silica gels; however, due to their high regeneration temperatures, regeneration of these two materials requires great power consumption and a considerable consequential increase in the operation costs. In addition, as environmental issues have become highly regarded nowadays, new materials and methods to improve dehumidifying efficiency as a whole, using the least power consumption, is no doubt the trend for the following century.

### SUMMARY OF THE INVENTION

In accordance with the present invention, a new moisture-absorbing polymer particle is provided. This particle can meet the requirement of low energy consumption and high dehumidifying efficiency.

One object of the present invention is to employ the thermo-sensitive properties of PNIPAm for moisture-adsorbing/dehumidifying usage. When at a temperature lower than its LCST (lower critical solution temperature), the PNIPAm copolymer particles are hydrophilic and have a capacity to be swollen several times larger than its original volume. When at a temperature higher than its LCST, the polymer chains contract and the PNIPAm copolymer particles become hydrophobic and can be rapidly dewatered. The present invention is characterized by the above-mentioned low-regeneration temperature feature and through which the present invention provides a moisture-absorbing polymer particle which can serve as an energy saving dehumidifier at normal room temperature. Therefore, this present invention does have the economic advantages for industrial applications.

Accordingly, the present invention discloses a moisture-absorbing polymer particle, which either comprises PNIPAm crosslinking copolymer or a structure having PNIPAm crosslinking copolymer as a core and polymer with sulfonic acid group as a shell. The present invention also discloses a method for producing the provided moisture-absorbing polymer particle and an application thereof; the application is referred to as a continuous dehumidifying system which comprises a first module to perform a dehumidifying process and a second module to perform a regeneration process, wherein the dehumidifying process is performed at a temperature lower than 33° C. and the regeneration process is performed at a temperature higher than 40° C.

### BRIEF DESCRIPTION OF THE DRAWINGS

FIG. 1 is a flow chart of a method for forming a moisture-absorbing polymer particle in accordance with a third embodiment of the present invention;

FIG. 2 is a schematic diagram illustrating a continuous dehumidifying system in accordance with a fourth embodiment of the present invention; and

FIG. 3 is a schematic diagram illustrating a continuous dehumidifying system in accordance with a fifth embodiment of the present invention.

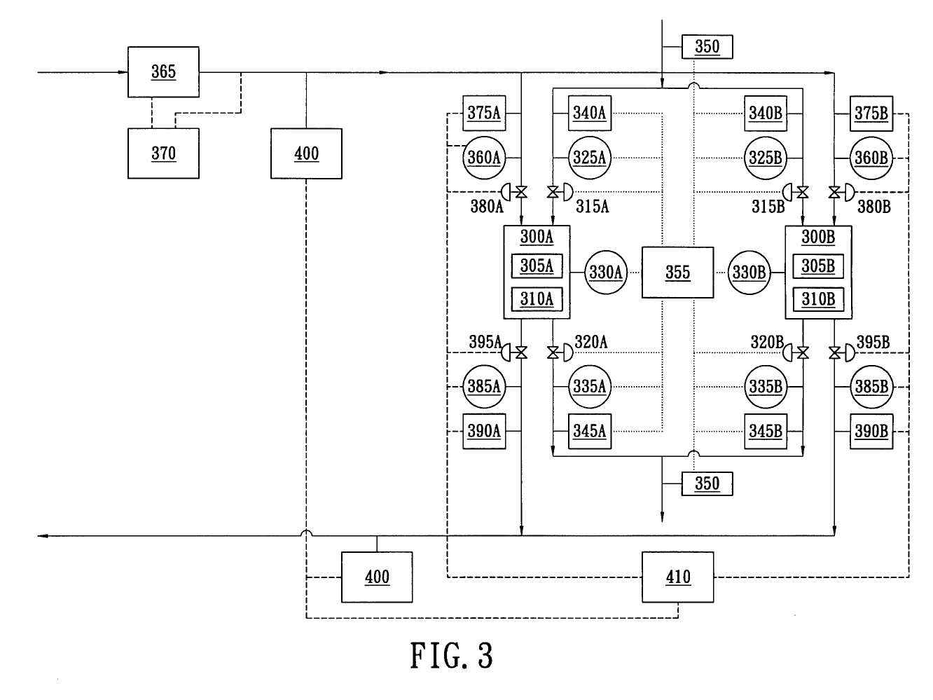

### DESCRIPTION OF THE PREFERRED EMBODIMENTS

What is probed into the invention is moisture-absorbing polymer particle, method for forming the same and application thereof. Detailed descriptions of the production, structure and elements will be provided in the following in order to make the invention thoroughly understood. Obviously, the application of the invention is not confined to specific details familiar to those who are skilled in the moisture-absorbing polymer particle. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, there is provided a moisture-absorbing polymer particle which comprises poly-N-isopropylacrylamide (PNIPAm] crosslinking colymer. The crosslinking copolymer is polymerized by N-isopropylacrylamide (NIPAm), as a monomer, with an acrylamide-type crosslinker having at least two double bonds, wherein the acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide. The amount of the acrylamide-type crosslinker added is selected 0.5 wt %˜6 wt % of NIPAm with a preferred value of 2 wt %.

In a second embodiment of the present invention, there is provided a moisture-absorbing polymer particle with a structure of a core, mainly PNIPAm, and a shell comprising polymer with sulfonic acid group. The core comprises PNIPAm crosslinking copolymer and is polymerized by NIPAm with an acrylamide-type crosslinker having at least two double bonds, wherein the acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide. The amount of the acrylamide-type crosslinker added is selected 0.5 wt %˜6 wt % of NIPAm with a preferred value of 2 wt %. Further, the polymer of the shell further comprises [poly(styrene sulfonic acid)′ PSSA].

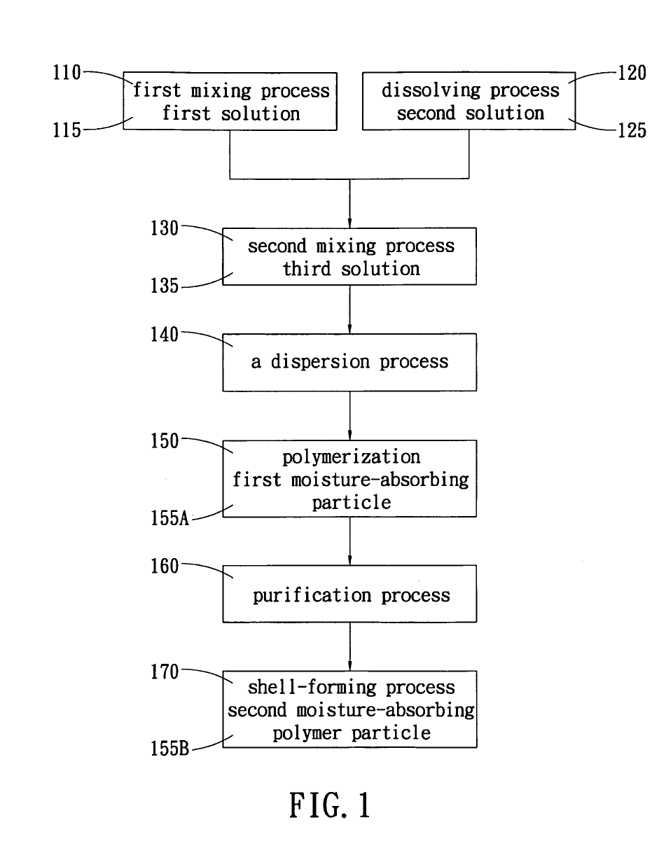

Referring to FIG. 1, in a third embodiment of the present invention, a method for forming moisture-absorbing polymer particles is provided. First of all, a first mixing process 110 is performed to mix NIPAm an acrylamide-type crosslinker having at least two double bonds and water into a first solution 115, wherein the acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide. The amount of the acrylamide-type crosslinker added is selected 0.5 wt %˜6 wt % of NIPAm with a preferred value of 2 wt %. Next, a dissolving process 120 is performed to dissolve a water-soluble initiator containing ammonium persulfate(APS) into water to form a second solution 125. The amount of the water-soluble initiator to use is selected 0.5 wt %˜2 wt % of NIPAm. Then, a second mixing process 130 is performed at a specific temperature to mix the first solution 115 with the second solution 125 to form a third solution 135, wherein the specific temperature is lower than 33° C. Next, a dispersion process 140 is performed at the specific temperature to uniformly distribute a plurality of liquid drops containing the third solution 135 in an organic solvent containing toluene, so as to form a water-in-oil system. Afterwards, a catalyst containing N,N,N′,N′,-Tetramethylethylendiamine (TEMED) is added into the organic solvent for starting and accelerating a polymerization 150 in the liquid drops, wherein the NIPAm and the acrylamide-type crosslinker are polymerized into a first moisture-absorbing polymer particle 155A. In detail, the first moisture-absorbing particle 155A is formed under a condition with inert gas purged, and the polymerization time is longer than 4 hours.

Referring to FIG. 1, in this embodiment, the provided method for forming moisture-absorbing polymer particles can further comprise at least one purification process 160 and a shell-forming process 170. The purification process 160 further comprises removing unreacted NIPAm, unreacted acrylamide-type crosslinker and impurities by an extracting agent (such as ketone), and removing the extracting agent by a cleaning agent (such as water). On the other hand, the shell-forming process 170 forms a shell region having sulfonic acid group onto the surface of the previous purified first moisture-absorbing polymer particle 155A, and through which to form a second moisture-absorbing polymer particle 155B. The shell-forming process 170 comprises: coating a 30 wt % [poly(styrene sulfonic acid), PSSA] solution onto the surface of the previous purified first moisture-absorbing polymer particle 155A; and performing a drying procedure to form a shell region having PSSA on the previous purified first moisture-absorbing polymer particle 155A.

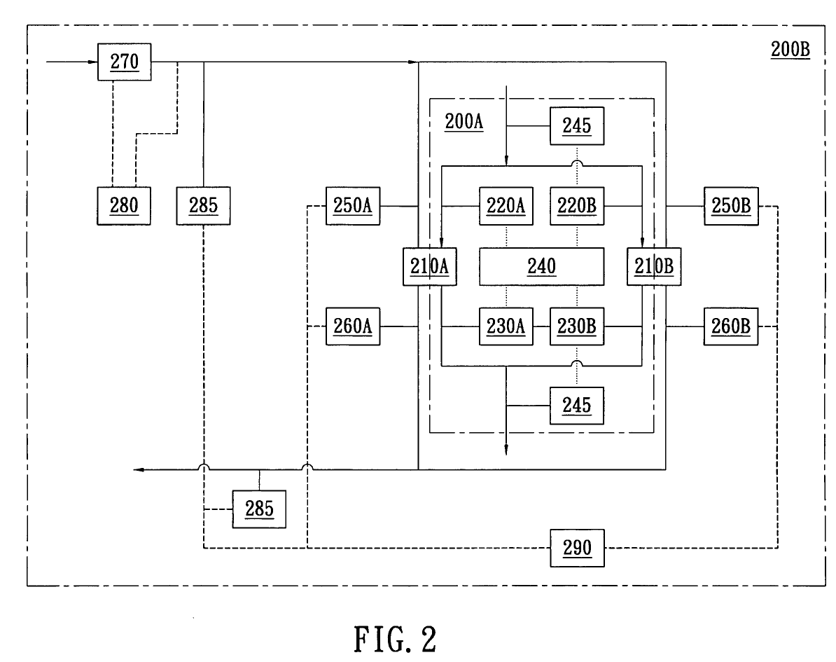

Referring to FIG. 2, in a fourth embodiment of the present invention, a continuous dehumidifying system is provided. The provided continuous dehumidifying system comprises a first module 200A to perform a dehumidifying process and a second module 200B to perform a regeneration process, wherein the first module comprises a plurality of moisture-absorbing polymer particles to process a humid gas stream inlet and generate a dried exhaust stream outlet; and the second module 200B processes the used moisture-absorbing polymer particles in the first module 200A; regenerates them and prepares for next dehumidifying process going to perform. The above mentioned moisture-absorbing polymer particles comprises poly-N-isopropylacrylamide (PNIPAm] crosslinking copolymer which is polymerized by NIPAm with an acrylamide-type crosslinker having at least two double bonds. The acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide. The amount of the acrylamide-type crosslinker added is selected 0.5 wt %˜6 wt % of NIPAm with a preferred value of 2 wt %. Alternatively, the moisture-absorbing polymer particle can have a shell which is made of a material having sulfonic acid group, such as [poly(styrene sulfonic acid), PSSA]. The dehumidifying process is performed at a temperature lower than 33° C. and the regeneration process is performed at a temperature higher than 40° C.

In this embodiment, the first module 200A further comprises a first absorbing device 210A and a second absorbing device 210B. The first absorbing device 210A and the second absorbing device 210B both contain the moisture-absorbing polymer particles and process the humid gas stream inlet and generate the exhaust gas stream in turn; a first control device 220A to lead the humid gas stream inlet into the first absorbing device 210A, detect the temperature of the humid gas stream inlet at the first inlet of the first absorbing device 210A and generate a first signal of temperature, and detect the dew point of the humid gas stream inlet at the first inlet of the first absorbing device 210A and generate a first signal of dew point; a second control device 230A to lead the exhaust gas stream generated in the first absorbing device 210A out of the first absorbing device 210A, detect the temperature of the exhaust gas stream at the first outlet of the first absorbing device 210A and generate a second signal of temperature, and detect the dew point of the exhaust gas stream at the first outlet of the first absorbing device 210A and generate a second signal of dew point; a third control device 220B to lead the humid gas stream inlet into the second absorbing device 210B, detect the temperature of the humid gas stream inlet at the first inlet of the second absorbing device 210B and generate a third signal of temperature, and detect the dew point of the humid gas stream inlet at the first inlet of the second absorbing device 210B and generate a third signal of dew point; a fourth control device 230B to lead the exhaust gas stream generated in the second absorbing device 210B out of the second absorbing device 210B, detect the temperature of the exhaust gas stream at the first outlet of the second absorbing device 210B and generate a fourth signal of temperature, and detect the dew point of the exhaust gas stream at the first outlet of the second absorbing device 210B and generate a fourth signal of dew point; a first driving device 245 to provide driving force for leading the humid gas stream inlet into the first absorbing device 210A or the second absorbing device 210B, and for leading the exhaust gas stream out of the first absorbing device 210A or the second absorbing device 210B, further, the first driving device 245 can adjust the gas flow rate and according to which generate a first signal of flow rate; and a first central processing device 240 to receive the first signal of temperature, the second signal of temperature, the first signal of dew point, the second signal of dew point, and the first signal of flow rate to determine a first feed humidity describing the humid gas stream inlet at the first inlet of the first absorbing device 210A and a first exhaust humidity describing the exhaust gas stream at the first outlet of the first absorbing device 210A, on the other hand, the first central processing device 240 receives the third signal of temperature, the fourth signal of temperature, the third signal of dew point and the fourth signal of dew point, and combine with the first signal of flow rate, to determine a second feed humidity describing the humid gas stream inlet at the first inlet of the second absorbing device 210B and a second exhaust humidity describing the exhaust gas stream at the first outlet of the second absorbing device 210B.

In this embodiment, when the ratio of the first exhaust humidity to the first feed humidity reaches a certain set point, the first central processing device 240 generates a switching signal to disable the first control device 220A and the second control device 230A, and enable the third control device 220B and the fourth control device 230B, through which to enable the dehumidifying process performed by the second absorbing device 210B and disable the dehumidifying process performed by the first absorbing device 210A. On the other hand, when the ratio of the second exhaust humidity to the second feed humidity reaches a certain set point, the first central processing device 240 generates a switching signal to disable the third control device 220B and the fourth control device 230B, and enable the first control device 220A and the second control device 230A, through which to enable the dehumidifying process performed by the first absorbing device 210A and disable the dehumidifying process performed by the second absorbing device 210B.

In this embodiment, the second module 220B further comprises a second central processing device 280 to detect the temperature of a regeneration feed gas and generate an instant control signal; a heating device 270 to receive the control signal and adjust the temperature of the regeneration feed gas to a regeneration temperature, the regeneration feed gas absorbs the moisture contained in the used moisture-absorbing polymer particles in the first absorbing device 210A or the second absorbing device 210B and forms a regeneration exhaust gas, whereupon the first module 200A can proceed next dehumidifying process utilizing the regenerated moisture-absorbing polymer particles; a fifth control device 250A to lead the regeneration feed gas into the first absorbing device 210A, detect the temperature of the regeneration feed gas at the second inlet of the first absorbing device 210A and generate a fifth signal of temperature, and detect the dew point of the regeneration feed gas at the second inlet of the first absorbing device 210A and generate a fifth signal of dew point; a sixth control device 260A to lead the regeneration exhaust gas generated in the first absorbing device 210A out of the first absorbing device 210A, detect the temperature of the regeneration exhaust gas at the second outlet of the first absorbing device 210A and generate a sixth signal of temperature, and detect the dew point of the regeneration exhaust gas at the second outlet of the first absorbing device 210A and generate a sixth signal of dew point; a seventh control device 250B to lead the regeneration feed gas into the second absorbing device 210B, detect the temperature of the regeneration feed gas at the second inlet of the second absorbing device 210B and generate a seventh signal of temperature, and detect the dew point of the regeneration feed gas at the second inlet of the second absorbing device 210B and generate a seventh signal of dew point; an eighth control device 260B to lead the regeneration exhaust gas generated in the second absorbing device 210B out of the second absorbing device 210B, detect the temperature of the regeneration exhaust gas at the second outlet of the second absorbing device 210B and generate an eighth signal of temperature, and detect the dew point of the regeneration exhaust gas at the second outlet of the second absorbing device 210B and generate an eighth signal of dew point; a second driving device 285 to provide driving force for leading the regeneration feed gas into the first absorbing device 210A or the second absorbing device 210B, and for leading the regeneration exhaust gas out of the first absorbing device 210A or the second absorbing device 210B, further, the second driving device 285 can adjust the gas flow rate and according to which generate a second signal of flow rate; and a third central processing device 290 to receive the fifth signal of temperature, the sixth signal of temperature, the fifth signal of dew point, the sixth signal of dew point, and the second signal of flow rate to determine a third feed humidity describing the regeneration feed gas at the second inlet of the first absorbing device 210A and a third exhaust humidity describing the regeneration exhaust gas at the second outlet of the first absorbing device 210A, on the other hand, the third central processing device 290 receives the seventh signal of temperature, the eighth signal of temperature, the seventh signal of dew point and the eighth signal of dew point, and combine with the second signal of flow rate, to determine a fourth feed humidity describing the regeneration feed gas at the second inlet of the second absorbing device 210B and a fourth exhaust humidity describing the regeneration exhaust gas at the second outlet of the second absorbing device 210B.

In this embodiment, when the third exhaust humidity equals the third feed humidity, the third central processing device 290 generates a switching signal to disable the fifth control device 250A and the sixth control device 260A, and enable the seventh control device 250B and the eighth control device 260B, through which to enable the regeneration process performed by the second absorbing device 210B and disable the regeneration process performed by the first absorbing device 210A. On the other hand, when the fourth exhaust humidity equals the fourth feed humidity, the third central processing device 290 generates a switching signal to disable the seventh control device 250B and the eighth control device 260B, and enable the fifth control device 250A and the sixth control device 260A, through which to enable the regeneration process performed by the first absorbing device 210A and disable the regeneration process performed by the second absorbing device 210B.

In a fifth embodiment of the present invention, a continuous dehumidifying system is provided. The provided continuous dehumidifying system comprises a first module to perform a dehumidifying process and a second module to perform a regeneration process, wherein the first module comprises a plurality of moisture-absorbing polymer particles to process a humid gas stream inlet and generate a exhaust gas stream; and the second module processes the used moisture-absorbing polymer particles in the first module; regenerate them and prepare for next dehumidifying process going to perform. The above mentioned moisture-absorbing polymer particles contain poly-N-isopropylacrylamide (PNIPAm] crosslinking copolymer which is polymerized by NIPAm with an acrylamide-type crosslinker having at least two double bonds. The acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide. The amount of the acrylamide-type crosslinker added is selected 0.5 wt %˜6 wt % of NIPAm with a preferred value of 2 wt %. Alternatively, the moisture-absorbing polymer particle can have a shell which is made of a material having sulfonic acid group, such as [poly(styrene sulfonic acid), PSSA]. What should be noticed is, the dehumidifying process is performed at a temperature lower than 33° C. and the regeneration process is performed at a temperature higher than 40° C.

In this embodiment, the first module further comprises a first absorbing device 300A and a second absorbing device 300B. The first absorbing device 300A and the second absorbing device 300B both contain moisture-absorbing polymer particles and process the humid gas stream inlet and generate the exhaust gas stream in turn; a plurality of moisture-absorbing polymer particles 305A in the first absorbing device 300A and a plurality of moisture-absorbing polymer particles 305B in the second absorbing device 300B were used to absorb the moisture contained in the humid gas stream inlet; two supporting devices 310A and 310B which are located in the bottom of the first absorbing device 300A and the second absorbing device 300B, respectively, each of the two supporting devices 310A and 310B is used for bearing a stack of the moisture-absorbing polymer particles of a certain height, and each of the two supporting devices 310A and 310B has a plurality of holes for ventilation; a first feed control valve 315A to lead the humid gas stream inlet into the first absorbing device 300A; a first exhaust control valve 320A to lead the exhaust gas stream out of the first absorbing device 300A; a second feed control valve 315B to lead the humid gas stream inlet into the second absorbing device 300B; a second exhaust control valve 320B to lead the exhaust gas stream out of the second absorbing device 300B; a first temperature detector 325A to detect the temperature of the humid gas stream inlet at the first inlet of the first absorbing device 300A and generate a first signal of temperature; a second temperature detector 330A to detect the gas temperature at half the certain height of the moisture-absorbing polymer particle stack in the first absorbing device 300A and generate a second signal of temperature; and a third temperature detector 335A to detect the temperature of the exhaust gas stream at the first outlet of the first absorbing device 300A and generate a third signal of temperature.

In this embodiment, the first module further comprises a fourth temperature detector 325B to detect the temperature of the humid gas stream inlet at the first inlet of the second absorbing device 300B and generate a fourth signal of temperature; a fifth temperature detector 330B to detect the gas temperature at half the certain height of the moisture-absorbing polymer particle stack in the second absorbing device 300B and generate a fifth signal of temperature; a sixth temperature detector 335B to detect the temperature of the exhaust gas stream at the first outlet of the second absorbing device 300B and generate a sixth signal of temperature; a first dew point meter 340A to detect the dew point of the humid gas stream inlet at the first inlet of the first absorbing device 300A and generate a first signal of dew point; a second dew point meter 345A to detect the dew point of the exhaust gas stream at the first outlet of the first absorbing device 300A and generate a second signal of dew point; a third dew point meter 340B to detect the dew point of the humid gas stream inlet at the first inlet of the second absorbing device 300B and generate a third signal of dew point; a fourth dew point meter 345B to detect the dew point of the exhaust gas stream at the first outlet of the second absorbing device 300B and generate a fourth signal of dew point; a first driving device 350 to provide driving force for leading the humid gas stream inlet into the first absorbing device 300A or the second absorbing device 300B, and for leading the exhaust gas stream out of the first absorbing device 300A or the second absorbing device 300B, further, the first driving device 350 can adjust the gas flow rate and according to which generate a first signal of flow rate; and a first central processing device 355 to receive the first signal of temperature, the second signal of temperature, the third signal of temperature, the first signal of dew point, the second signal of dew point, and the first signal of flow rate to determine a first feed humidity describing the humid gas stream inlet at the first inlet of the first absorbing device 300A and a first exhaust humidity describing the exhaust gas stream at the first outlet of the first absorbing device 300A, on the other hand, the first central processing device 355 receives the fourth signal of temperature, the fifth signal of temperature, the sixth signal of temperature, the third signal of dew point and the fourth signal of dew point, and combine with the first signal of flow rate, to determine a second feed humidity describing the humid gas stream inlet at the first inlet of the second absorbing device 300B and a second exhaust humidity describing the exhaust gas stream at the first outlet of the second absorbing device 300B.

In this embodiment, a plurality of spheres are further stacked both on top of and under the plurality of moisture-absorbing polymer particles, in order to allow an uniform contact between the gas and the polymer particles. Additionally, at least two porous films are placed both on top of and under the particles or spheres, through which to avoid particles or spheres blow away. Moreover, the first module has a defogger to remove liquid micro-drops carried by the humid gas stream inlet; and the first driving device 350 has an air pump for providing driving force for the gas flow, and a flow rate controller for controlling the gas flow rate. In operation, when the ratio of the first exhaust humidity to the first feed humidity reaches a certain set point, the first central processing device 355 generates a switching signal to disable the first feed control valve 315A and the first exhaust control valve 320A, and enable the second feed control valve 315B and the second exhaust control valve 320B, through which to enable the dehumidifying process performed by the second absorbing device 300B and disable the dehumidifying process performed by the first absorbing device 300A. On the other hand, when the ratio of the second exhaust humidity to the second feed humidity reaches a certain set point, the first central processing device 355 generates a switching signal to disable the second feed control valve 315B and the second exhaust control valve 320B, and enable the first feed control valve 315A and the first exhaust control valve 320A, through which to enable the dehumidifying process performed by the first absorbing device 300A and disable the dehumidifying process performed by the second absorbing device 300B.

In this embodiment, the second module further comprises a second central processing device 370 to detect the temperature of a regeneration feed gas and generate an instant control signal; a heating device 365 to receive the control signal and adjust the temperature of the regeneration feed gas to a regeneration temperature, the regeneration feed gas absorbs the moisture contained in the used moisture-absorbing polymer particles in the first absorbing device 300A or the second absorbing device 300B and forms a regeneration exhaust gas, whereupon the first module can proceed next dehumidifying process utilizing the regenerated moisture-absorbing polymer particles; a third feed control valve 380A to lead the regeneration feed gas into the first absorbing device 300A; a third exhaust control valve 395A to lead the exhaust gas stream generated in the first absorbing device 300A out of the first absorbing device 300A; a fourth feed control valve 380A to lead the regeneration feed gas into the second absorbing device 300B; a fourth exhaust control valve 395B to lead the regeneration exhaust gas generated in the second absorbing device 300B out of the second absorbing device 300B; a seventh temperature detector 360A to detect the temperature of the regeneration feed gas at the second inlet of the first absorbing device 300A and generate a seventh signal of temperature; an eighth temperature detector 385A to detect the temperature of the regeneration exhaust gas at the second outlet of the first absorbing device 300A and generate an eighth signal of temperature; a ninth temperature detector 360B to detect the temperature of the regeneration feed gas at the second inlet of the second absorbing device 300B and generate a ninth signal of temperature; and a tenth temperature detector 385B to detect the temperature of the regeneration exhaust gas at the second outlet of the second absorbing device 300B and generate a tenth signal of temperature.

In this embodiment, the second module further comprises a fifth dew point meter 375A to detect the dew point of the regeneration feed gas at the second inlet of the first absorbing device 300A and generate a fifth signal of dew point; a sixth dew point meter 390A to detect the dew point of the regeneration exhaust gas at the second outlet of the first absorbing device 300A and generate a sixth signal of dew point; a seventh dew point meter 375B to detect the dew point of the regeneration feed gas at the second inlet of the second absorbing device 300B and generate a seventh signal of dew point; an eighth dew point meter 390B to detect the dew point of the regeneration exhaust gas at the second outlet of the second absorbing device 300B and generate an eighth signal of dew point; a second driving device 400 to provide driving force for leading the regeneration feed gas into the first absorbing device 300A or the second absorbing device 300B, and for leading the regeneration exhaust gas out of the first absorbing device 300A or the second absorbing device 300B, further, the second driving device 400 can adjust the gas flow rate and according to which generate a second signal of flow rate; and a third central processing device 410 to receive the seventh signal of temperature, the eighth signal of temperature, the fifth signal of dew point, the sixth signal of dew point, and the second signal of flow rate to determine a third feed humidity describing the regeneration feed gas at the second inlet of the first absorbing device 300A and a third exhaust humidity describing the regeneration exhaust gas at the second outlet of the first absorbing device 300A, on the other hand, the third central processing device 410 receives the ninth signal of temperature, the tenth signal of temperature, the seventh signal of dew point and the eighth signal of dew point, and combine with the second signal of flow rate, to determine a fourth feed humidity describing the regeneration feed gas at the second inlet of the second absorbing device 300B and a fourth exhaust humidity describing the regeneration exhaust gas at the second outlet of the second absorbing device 300B.

In this embodiment, when the third exhaust humidity equals the third feed humidity, the third central processing device 410 generates a switching signal to disable the third feed control valve 380A and the third exhaust control valve 395A, and enable the fourth feed control valve 380B and the fourth exhaust control valve 395B, through which to enable the regeneration process performed by the second absorbing device 300B and disable the regeneration process performed by the first absorbing device 300A. On the other hand, when the fourth exhaust humidity equals the fourth feed humidity, the third central processing device 410 generates a switching signal to disable the fourth feed control valve 380B and the fourth exhaust control valve 395B, and enable the third feed control valve 380A and the third exhaust control valve 395A, through which to enable the regeneration process performed by the first absorbing device 300A and disable the regeneration process performed by the second absorbing device 300B.

In the above preferred embodiments, the present invention employs the thermo-sensitive properties of PNIPAm for moisture-adsorbing/dehumidifying usage. When at a temperature lower than its LCST (lower critical solution temperature), the PNIPAm copolymer particles are hydrophilic and have a capacity to be swollen several times larger than its original volume. When at a temperature higher than its LCST, the polymer chains contract and the PNIPAm copolymer particles become hydrophobic and can be rapidly dewatered. The present invention is characterized by the above-mentioned low-regeneration temperature feature and through which the present invention provides a moisture-absorbing polymer particle which can serve as an energy saving dehumidifier at normal room temperature. Therefore, this present invention does have the economic advantages for industrial applications.

To sum up, the present invention discloses a moisture-absorbing polymer particle, which either comprises PNIPAm crosslinking copolymer or a structure having PNIPAm crosslinking copolymer as a core and polymer with sulfonic acid group as a shell. The present invention also discloses a method for producing the provided moisture-absorbing polymer particle and an application thereof; the application is referred to as a continuous dehumidifying system which comprises a first module to perform a dehumidifying process and a second module to perform a regeneration process, wherein the dehumidifying process is performed at a temperature lower than 33° C. and the regeneration process is performed at a temperature higher than 40° C.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. a continuous dehumidifying system, comprising:
a first module to perform a dehumidifying process, said first module comprises a plurality of moisture-absorbing polymer particles to process a humid gas stream inlet and generate a dried exhaust stream outlet; and
a second module to perform a regeneration process, said second module processes used said plurality of moisture-absorbing polymer particles in said first module; regenerate them and prepare for next dehumidifying process going to perform, said plurality of moisture-absorbing polymer particles further comprises poly-N-isopropylacrylamide (PNIPAm] crosslinking copolymer.

2. The continuous dehumidifying system in claim 1, wherein said dehumidifying process is performed at a temperature lower than 33° C.

3. The continuous dehumidifying system in claim 1, wherein said regeneration process is performed at a temperature higher than 40° C.

4. The continuous dehumidifying system in claim 1, wherein said first module further comprises:
a first absorbing device and a second absorbing device, said first absorbing device and said second absorbing device both contain said plurality of moisture-absorbing polymer particles and process said humid gas stream inlet and generate said exhaust gas stream in turn;
a first control device to lead said humid gas stream inlet into said first absorbing device, detect the temperature of the humid gas stream inlet at a first inlet of the first absorbing device and generate a first signal of temperature, and detect the dew point of said humid gas stream inlet at said first inlet of said first absorbing device and generate a first signal of dew point;
a second control device to lead said exhaust gas stream generated in said first absorbing device out of said first absorbing device, detect the temperature of said exhaust gas stream at a first outlet of said first absorbing device and generate a second signal of temperature, and detect the dew point of said exhaust gas stream at said first outlet of said first absorbing device and generate a second signal of dew point;
a third control device to lead said humid gas stream inlet into said second absorbing device, detect the temperature of said humid gas stream inlet at a first inlet of said second absorbing device and generate a third signal of temperature, and detect the dew point of said humid gas stream inlet at said first inlet of said second absorbing device and generate a third signal of dew point;
a fourth control device to lead said exhaust gas stream generated in said first absorbing device out of said second absorbing device, detect the temperature of said exhaust gas stream at a first inlet of said second absorbing device and generate a fourth signal of temperature, and detect the dew point of said exhaust gas stream at said first outlet of said second absorbing device and generate a fourth signal of dew point;
a first driving device to provide driving force for leading the humid gas stream inlet into said first absorbing device or said second absorbing device, and for leading said exhaust gas stream out of said first absorbing device or said second absorbing device, further, said first driving device can adjust the gas flow rate and according to which generate a first signal of flow rate; and
a first central processing device to receive said first signal of temperature, said second signal of temperature, said first signal of dew point, said second signal of dew point, and said first signal of flow rate to determine a first feed humidity describing said humid gas stream inlet at said first inlet of the first absorbing device and a first exhaust humidity describing said exhaust gas stream at said first outlet of said first absorbing device, on the other hand, said first central processing device receives said third signal of temperature, said fourth signal of temperature, said third signal of dew point and said fourth signal of dew point, and combine with said first signal of flow rate, to determine a second feed humidity describing said humid gas stream inlet at said first inlet of said second absorbing device and a second exhaust humidity describing said exhaust gas stream at said first outlet of said second absorbing device.

5. The continuous dehumidifying system in claim 4, wherein when the ratio of said first exhaust humidity to said first feed humidity reaches a certain set point, said first central processing device generates a switching signal to disable said first control device and said second control device, and enable said third control device and said fourth control device, through which to enable said dehumidifying process performed by said second absorbing device and disable said dehumidifying process performed by said first absorbing device.

6. The continuous dehumidifying system in claim 4, wherein when the ratio of said second exhaust humidity to said second feed humidity reaches a certain set point, said first central processing device generates a switching signal to disable said third control device and said fourth control device, and enable said first control device and said second control device, through which to enable said dehumidifying process performed by said first absorbing device and disable said dehumidifying process performed by said second absorbing device.

7. The continuous dehumidifying system in claim 1, wherein said second module further comprises:
a second central processing device to detect the temperature of a regeneration feed gas and generate an instant control signal;
a heating device to receive said control signal and adjust the temperature of said regeneration feed gas to a regeneration temperature, said regeneration feed gas absorbs the moisture contained in used said plurality of moisture-absorbing polymer particles in said first absorbing device or said second absorbing device and forms a regeneration exhaust gas, whereupon said first module can proceed next dehumidifying process utilizing regenerated said moisture-absorbing polymer particles;
a fifth control device to lead said regeneration feed gas into said first absorbing device, detect the temperature of said regeneration feed gas at a second inlet of said first absorbing device and generate a fifth signal of temperature, and detect the dew point of said regeneration feed gas at said second inlet of said first absorbing device and generate a fifth signal of dew point;
a sixth control device to lead said regeneration exhaust gas generated in said first absorbing device out of said first absorbing device, detect the temperature of said regeneration exhaust gas at a second outlet of said first absorbing device and generate a sixth signal of temperature, and detect the dew point of said regeneration exhaust gas at said second outlet of said first absorbing device and generate a sixth signal of dew point;
a seventh control device to lead said regeneration feed gas into said second absorbing device, detect the temperature of said regeneration feed gas at a second inlet of said second absorbing device and generate a seventh signal of temperature, and detect the dew point of said regeneration feed gas at said second inlet of said second absorbing device and generate a seventh signal of dew point;
an eighth control device to lead said regeneration exhaust gas generated in said second absorbing device out of said second absorbing device, detect the temperature of said regeneration exhaust gas at said second outlet of said second absorbing device and generate an eighth signal of temperature, and detect the dew point of said regeneration exhaust gas at said second outlet of said second absorbing device and generate an eighth signal of dew point;
a second driving device to provide driving force for leading said regeneration feed gas into said first absorbing device or said second absorbing device, and for leading said regeneration exhaust gas out of said first absorbing device or said second absorbing device, further, said second driving device can adjust the gas flow rate and according to which generate a second signal of flow rate; and
a third central processing device to receive said fifth signal of temperature, said sixth signal of temperature, said fifth signal of dew point, said sixth signal of dew point, and said second signal of flow rate to determine a third feed humidity describing said regeneration feed gas at said second inlet of said first absorbing device and a third exhaust humidity describing said regeneration exhaust gas at said second outlet of said first absorbing device, on the other hand, said third central processing device receives said seventh signal of temperature, said eighth signal of temperature, said seventh signal of dew point and said eighth signal of dew point, and combine with said second signal of flow rate, to determine a fourth feed humidity describing said regeneration feed gas at said second inlet of said second absorbing device and a fourth exhaust humidity describing said regeneration exhaust gas at said second outlet of said second absorbing device.

8. The continuous dehumidifying system in claim 7, wherein when said third exhaust humidity equals said third feed humidity, said third central processing device generates a switching signal to disable said fifth control device and said sixth control device, and enable said seventh control device and said eighth control device, through which to enable said regeneration process performed by said second absorbing device and disable said regeneration process performed by said first absorbing device.

9. The continuous dehumidifying system in claim 7, wherein when said fourth exhaust humidity equals said fourth feed humidity, said third central processing device generates a switching signal to disable said seventh control device and said eighth control device, and enable said fifth control device and said sixth control device, through which to enable said regeneration process performed by said first absorbing device and disable said regeneration process performed by said second absorbing device.

10. The continuous dehumidifying system in claim 1, wherein said PNIPAm crosslinking copolymer is polymerized by NIPAm and a acrylamide-type crosslinker having at least two double bonds.

11. The continuous dehumidifying system in claim 10, wherein said acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide.

12. The continuous dehumidifying system in claim 10, wherein the amount of said acrylamide-type crosslinker added is selected 0.5 wt %˜6 wt % of NIPAm.

13. The continuous dehumidifying system in claim 10, wherein the preferred amount of said acrylamide-type crosslinker added is 2 wt % of NIPAm.

14. The continuous dehumidifying system in claim 1, wherein said moisture-absorbing polymer particle has a shell region having sulfonic acid group.

15. The continuous dehumidifying system in claim 14, wherein the material of said shell is [poly(styrene sulfonic acid), PSSA).

16. A continuous dehumidifying system, comprising:
a first module to perform a dehumidifying process, said first module comprises a plurality of moisture-absorbing polymer particles to process a humid gas stream inlet and generate a dried exhaust stream outlet; and
a second module to perform a regeneration process, said second module processes used said plurality of moisture-absorbing polymer particles in said first module; regenerate them and prepare for next dehumidifying process going to perform, said plurality of moisture-absorbing polymer particles further comprises poly-N-isopropylacrylamide (PNIPAm] crosslinking copolymer.

17. The continuous dehumidifying system in claim 16, wherein said dehumidifying process is performed at a temperature lower than 33° C.

18. The continuous dehumidifying system in claim 16, wherein said regeneration process is performed at a temperature higher than 40° C.

19. The continuous dehumidifying system in claim 16, wherein said first module further comprises:
a first absorbing device and a second absorbing device, said first absorbing device and said second absorbing device both contain said plurality of moisture-absorbing polymer particles and process said humid gas stream inlet and generate said exhaust gas stream in turn;
said plurality of moisture-absorbing polymer particles in said first absorbing device and the second absorbing device, were used to absorb the moisture contained in said humid gas stream inlet;
two supporting devices which are located in the bottom of said first absorbing device and said second absorbing device, respectively, each of said two supporting devices is used for bearing a stack of said plurality of moisture-absorbing polymer particles of a certain height, and each of said two supporting devices has a plurality of holes for ventilation;
a first feed control valve to lead said humid gas stream inlet into said first absorbing device;
a first exhaust control valve to lead said exhaust gas stream generated in said first absorbing device out of said first absorbing device;
a second feed control valve to lead said humid gas stream inlet into said second absorbing device;
a second exhaust control valve to lead said exhaust gas stream generated in said second absorbing device out of said second absorbing device;
a first temperature detector to detect the temperature of said humid gas stream inlet at a first inlet of said first absorbing device and generate a first signal of temperature;
a second temperature detector to detect the gas temperature at half said certain height of said plurality of moisture-absorbing polymer particle stack in said first absorbing device and generate a first signal of temperature;
a third temperature detector to detect the temperature of said exhaust gas stream at a first outlet of said first absorbing device and generate a third signal of temperature;
a fourth temperature detector to detect the temperature of said humid gas stream inlet at a first inlet of said second absorbing device and generate a fourth signal of temperature;
a fifth temperature detector to detect the gas temperature at half said certain height of said plurality of moisture-absorbing polymer particle stack in said second absorbing device and generate a fifth signal of temperature;
a sixth temperature detector to detect the temperature of said exhaust gas stream at a first outlet of said second absorbing device and generate a sixth signal of temperature;
a first dew point meter to detect the dew point of said humid gas stream inlet at said first inlet of said first absorbing device and generate a first signal of dew point;
a second dew point meter to detect the dew point of said exhaust gas stream at said first outlet of said first absorbing device and generate a second signal of dew point;
a third dew point meter to detect the dew point of said humid gas stream inlet at said first inlet of said second absorbing device and generate a third signal of dew point;
a fourth dew point meter to detect the dew point of said exhaust gas stream at said first outlet of said second absorbing device and generate a fourth signal of dew point;
a first driving device to provide driving for leading said humid gas stream inlet into said first absorbing device or said second absorbing device, and for leading said exhaust gas stream out of said first absorbing device or said second absorbing device, further, said first driving device can adjust the gas flow rate and according to which generate a first signal of flow rate; and
a first central processing device to receive said first signal of temperature, said second signal of temperature, said third signal of temperature, said first signal of dew point, said second signal of dew point, and said first signal of flow rate to determine a first feed humidity describing said humid gas stream inlet at said first inlet of said first absorbing device and a first exhaust humidity describing said exhaust gas stream at said first outlet of said first absorbing device, on the other hand, said first central processing device receives said fourth signal of temperature, said fifth signal of temperature, said sixth signal of temperature, said third signal of dew point and said fourth signal of dew point, and combine with said first signal of flow rate, to determine a second feed humidity describing said humid gas stream inlet at said first inlet of said second absorbing device and a second exhaust humidity describing said exhaust gas stream at said first outlet of said second absorbing device.

20. The continuous dehumidifying system in claim 19, wherein a plurality of spheres are further stacked both on top of and under said plurality of moisture-absorbing polymer particles, in order to allow an uniform contact between the gas and the polymer particles.

21. The continuous dehumidifying system in claim 19, wherein said first module has a defogger to remove liquid micro-drops carried by said humid gas stream inlet.

22. The continuous dehumidifying system in claim 19, wherein said first driving device has an air pump for providing driving force for the gas flow, and a flow rate controller for controlling the gas flow rate.

23. The continuous dehumidifying system in claim 19, wherein when the ratio of said first exhaust humidity to said first feed humidity reaches a certain set point, said first central processing device generates a switching signal to disable said first feed control valve and said first exhaust control valve, and enable said second feed control valve and said second exhaust control valve, through which to enable said dehumidifying process performed by said second absorbing device and disable said dehumidifying process performed by said first absorbing device.

24. The continuous dehumidifying system in claim 19, wherein when the ratio of said second exhaust humidity to said second feed humidity reaches a certain set point, said first central processing device generates a switching signal to disable said second feed control valve and said second exhaust control valve, and enable said first feed control valve and said first exhaust control valve, through which to enable said dehumidifying process performed by said first absorbing device and disable said dehumidifying process performed by said second absorbing device.

25. The continuous dehumidifying system in claim 16, wherein said second module further comprises:
a second central processing device to detect the temperature of a regeneration feed gas and generate an instant control signal;
a heating device to receive said control signal and adjust the temperature of said regeneration feed gas to a regeneration temperature, said regeneration feed gas absorbs the moisture contained in used said moisture-absorbing polymer particles in said first absorbing device or said second absorbing device and forms a regeneration exhaust gas, whereupon said first module can proceed next dehumidifying process utilizing regenerated said moisture-absorbing polymer particles;
a third feed control valve to lead said regeneration feed gas into said first absorbing device;
a third exhaust control valve to lead a regeneration exhaust gas generated in said first absorbing device out of said first absorbing device;
a fourth feed control valve to lead said regeneration feed gas into said second absorbing device;
a fourth exhaust control valve to lead a regeneration exhaust gas generated in said second absorbing device out of said second absorbing device;
a seventh temperature detector to detect the temperature of said regeneration feed gas at a second inlet of said first absorbing device and generate a seventh signal of temperature;
an eighth temperature detector to detect the temperature of said regeneration exhaust gas at a second outlet of said first absorbing device and generate an eighth signal of temperature;
a ninth temperature detector to detect the temperature of said regeneration feed gas at a second inlet of said second absorbing device and generate a ninth signal of temperature;
a tenth temperature detector to detect the temperature of said regeneration exhaust gas at a second outlet of said second absorbing device and generate a tenth signal of temperature.
a fifth dew point meter to detect the dew point of said regeneration feed gas at said second inlet of said first absorbing device and generate a fifth signal of dew point;
a sixth dew point meter to detect the dew point of said regeneration exhaust gas at said second outlet of said first absorbing device and generate a sixth signal of dew point;
a seventh dew point meter to detect the dew point of said regeneration feed gas at said second inlet of said second absorbing device and generate a seventh signal of dew point;
an eighth dew point meter to detect the dew point of said regeneration exhaust gas at said second outlet of said second absorbing device and generate an eighth signal of dew point;
a second driving device to provide driving for leading said regeneration feed gas into said first absorbing device or said second absorbing device, and for leading said regeneration exhaust gas out of said first absorbing device or said second absorbing device, further, said second driving device can adjust the gas flow rate and according to which generate a second signal of flow rate; and
a third central processing device to receive said seventh signal of temperature, said eighth signal of temperature, said fifth signal of dew point, said sixth signal of dew point, and said second signal of flow rate to determine a third feed humidity describing said regeneration feed gas at said second inlet of said first absorbing device and a third exhaust humidity describing said regeneration exhaust gas at said second outlet of said first absorbing device, on the other hand, said third central processing device receives said ninth signal of temperature, said tenth signal of temperature, said seventh signal of dew point and said eighth signal of dew point, and combine with said second signal of flow rate, to determine a fourth feed humidity describing said regeneration feed gas at said second inlet of said second absorbing device and a fourth exhaust humidity describing said regeneration exhaust gas at said second outlet of said second absorbing device.

26. The continuous dehumidifying system in claim 25, wherein when said third exhaust humidity equals said third feed humidity, said third central processing device generates a switching signal to disable said third feed control valve and said third exhaust control valve, and enable said fourth feed control valve and said fourth exhaust control valve, through which to enable said regeneration process performed by said second absorbing device and disable said regeneration process performed by said first absorbing device.

27. The continuous dehumidifying system in claim 25, wherein when said fourth exhaust humidity equals said fourth feed humidity, said third central processing device generates a switching signal to disable said fourth feed control valve and said fourth exhaust control valve, and enable said third feed control valve and said third exhaust control valve, through which to enable said regeneration process performed by said first absorbing device and disable said regeneration process performed by said second absorbing device.

28. The continuous dehumidifying system in claim 16, wherein said PNIPAm crosslinking copolymer is polymerized by NIPAm and a acrylamide-type crosslinker having at least two double bonds.

29. The continuous dehumidifying system in claim 28, wherein said acrylamide-type crosslinker is selected as anyone or any combination of the following: N,N′-diallyltartardiamide, N′-methylene-bisacrylamide(MBAAm), N,N′-hexamethylenebisacrylamide, N,N′-methylenebishydroxymethylacrylamide, and glyoxalbisacrylamide.

30. The continuous dehumidifying system in claim 28, wherein the amount of said acrylamide-type crosslinker added is selected 0.5 wt %˜6 wt % of NIPAm.

31. The continuous dehumidifying system in claim 28, wherein the preferred amount of said acrylamide-type crosslinker added is 2 wt % of NIPAm.

32. The continuous dehumidifying system in claim 16, wherein said moisture-absorbing polymer particle has a shell region having sulfonic acid group.

33. The continuous dehumidifying system in claim 32, wherein the material of said shell is [poly(styrene sulfonic acid), PSSA].
